(19) United States
(12) Patent Application Publication
(10) Pub. No.: US 2011/0200298 A1
(43) Pub. Date: Aug. 18, 2011

(54) PLAYBACK APPARATUS AND METHOD OF CONTROLLING THE SAME

(75) Inventors: Yuuichiro Aso, Hamura-shi (JP); Mikako Kobayashi, Fuchu-shi (JP)

(73) Assignee: KABUSHIKI KAISHA TOSHIBA, Tokyo (JP)

(21) Appl. No.: 13/028,988

(22) Filed: Feb. 16, 2011

(30) Foreign Application Priority Data
Feb. 16, 2010 (JP) 2010-031822

(51) Int. Cl. H04N 5/765; H04N 5/93; H04N 9/80

(52) U.S. Cl. 386/232; 386/353; 386/259; 386/E05.002; 386/E05.028; 386/E09.001

(57) ABSTRACT

According to one embodiment, a playback apparatus includes a graphic unit, a central unit, and a control unit. The graphic unit is configured to generate a video signal to be outputted to a display device. The central unit is configured to decode a coded moving image data, and to execute a program in order to generate a second moving image data to be inputted to the graphic unit based on the decoded moving image data. The control unit is configured to change a frame rate of a moving image data in accordance with a capability of the central unit.

### CROSS-REFERENCE TO RELATED APPLICATIONS

This application is based upon and claims the benefit of priority from Japanese Patent Application No. 2010-031822, filed Feb. 16, 2010; the entire contents of which are incorporated herein by reference.

### FIELD

Embodiments described herein relate generally to a playback apparatus, which plays back moving image data, and to a method of controlling a playback apparatus.

### BACKGROUND

Recently, a notebook personal computer including a processor having a main processor whose processing capability is low, a so-called Netbook, has been brought onto the market. The Netbook has a low processing capability, and in particular, the capability of playback a moving image such as a DVD video. In some cases, a dropped frame is unperiodically generated.

Jpn. Pat. Appln. KOKAI Publication No. 2002-108599 discloses the following technique. According to the technique, image data is transferred to a display device within a range of the maximum frame rate preset in accordance with the response speed of the display device. In this way, moving image data is displayed within a range of the capability of the display device.

### BRIEF DESCRIPTION OF THE DRAWINGS

A general architecture that implements the various feature of the embodiments will now be described with reference to the drawings. The drawings and the associated descriptions are provided to illustrate the embodiments and not to limit the scope of the invention.

FIG. 1 is an exemplary perspective view schematically showing the appearance of a playback apparatus according to one embodiment.

FIG. 2 is an exemplary block diagram showing the system configuration of the playback apparatus shown in FIG. 1.

FIG. 3 is an exemplary block diagram showing the configuration of a DVD application according to one embodiment of the present invention.

FIG. 4 is an exemplary view to explain I/P conversion in the case where 60-FPS moving image data according to one embodiment of the present invention are output.

FIG. 5 is an exemplary view to explain I/P conversion in the case where 30-FPS moving image data according to one embodiment of the present invention are output.

FIG. 6 is an exemplary flowchart to explain the procedure of setting a frame rate of moving image data output to a graphics processing unit (GPU) according to one embodiment of the present invention.

### DETAILED DESCRIPTION

Various embodiments will be described hereinafter with reference to the accompanying drawings.

In general, according to one embodiment, a playback apparatus includes a graphic unit, a central unit, and a control unit. The graphic unit is configured to generate a video signal to be outputted to a display device. The central unit is configured to decode a coded moving image data, and to execute a program in order to generate a second moving image data to be inputted to the graphic unit based on the decoded moving image data. The control unit is configured to change a frame rate of a moving image data in accordance with a capability of the central unit.

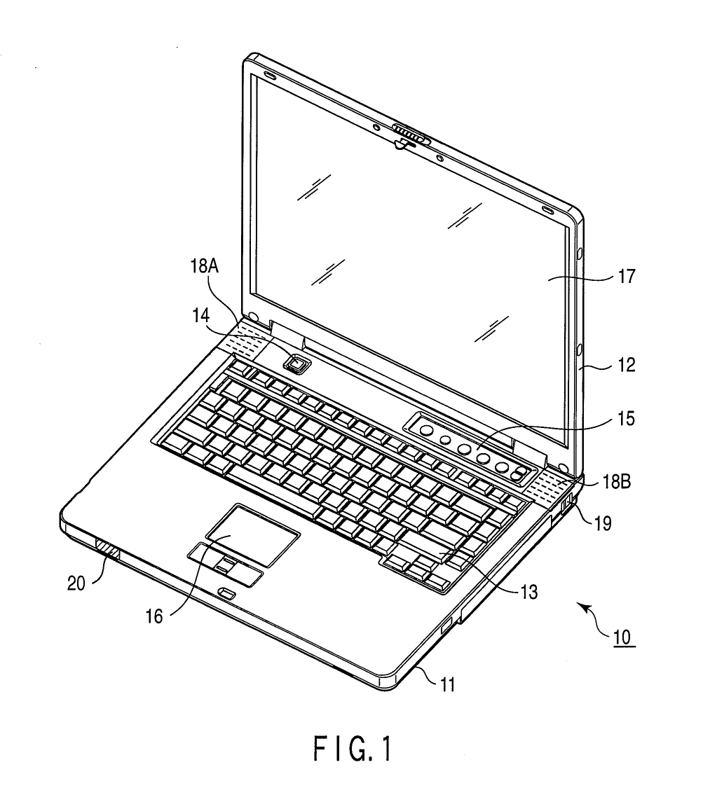

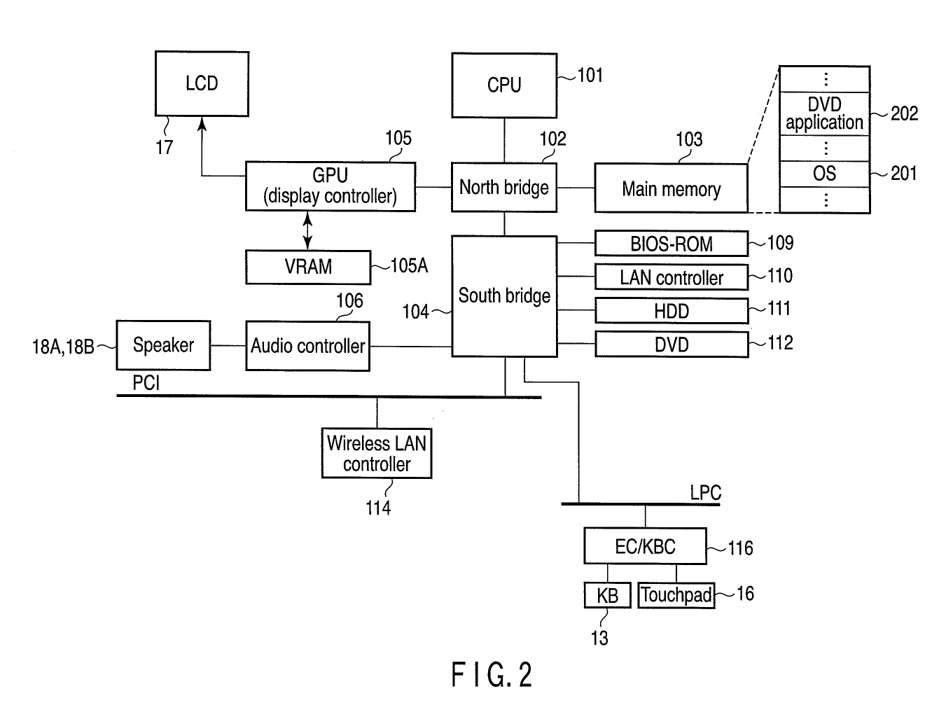

First, the configuration of a playback apparatus according to one embodiment of the present invention will be described with reference to FIGS. 1 and 2. For example, the playback apparatus of this embodiment is realized from a notebook and portable personal computer 10 functioning as an information processing apparatus.

The personal computer 10 is able to record and play back video content data (audio-visual content data) such as broadcast program data and video data input from an external device. In other words, the personal computer 10 has a television (TV) function for watching and recording broadcast program data broadcast by a television broadcasting signal. For example, the foregoing television TV function is realized by a television (TV) application program previously installed in the personal computer 10. Moreover, the television (TV) function has a function of recording video data input from an external audio-visual (AV) apparatus and a function of playback recorded video data and recorded broadcast program data.

FIG. 1 is a perspective view showing a state that a display unit of the computer 10 is opened. The computer 10 comprises a computer main body 11 and a display unit 12.

The display unit 12 is attached to the computer main body 11 so that it is freely rotatable between the following positions. One is an open position where the upper surface of the computer main body 11 is exposed. The other is a closed position where the display unit 12 covers the upper surface of the computer main body 11. The computer main body 11 has a thin box-shaped housing. The upper surface of the computer main body 11 is provided with a keyboard 13, a power button 14, an input control panel 15, a touchpad 16 and speakers 18A and 18B. The power button 14 turns on/off the power of the computer 10.

The input control panel 15 is an input device for inputting an event corresponding to a pressed button. The panel 15 is provided with a plurality of buttons for starting up each of a plurality of functions. The foregoing button group includes a control button for controlling a television (TV) function (watching, recording, playback recorded broadcast program data/video data).

The system configuration of the computer 10 will be described below with reference to FIG. 2.

As shown in FIG. 2, the computer 10 includes a CPU 101, a north bridge 102, a main memory 103, a south bridge 104, a graphics processing unit (GPU) 105, a video memory (VRAM) 105A, an audio controller 106 and a BIOS-ROM 109. Further, the computer 10 includes a LAN controller 110, a hard disk drive (HDD) 111, a DVD drive 112, a wireless LAN controller 114, an IEEE 1394 controller 115, an embedded controller/keyboard controller IC (EC/KBC) 116 and a television (TV) tuner 117.

The CPU 101 is a processor, which controls the operation of the computer 10. The CPU 101 executes an operating system (OS) 201 and various application programs such as a DVD application program 202, which are loaded from the hard disk drive (HDD) 111 from the main memory 103. The DVD application program 202 is software for playback a DVD loaded in the DVD drive 112. The DVD application program 202 is stored in the computer-readable medium. Further, the CPU 101 executes a Basic Input/Output System (BIOS) stored in the BIOS-ROM 109. The BIOS is a program for performing software control. For example, INTEL and ATOM® are used as the foregoing CPU 101.

The north bridge 102 is a bridge device, which makes a connection between a local bus of the CPU 101 and the south bridge 104. Further, the north bridge 102 has a built-in memory controller, which controls the access of the main memory 103. Further, the north bridge 102 has a function of performing a communication with the GPU 105 by means of a serial bus conforming to the PCI EXPRESS standard.

The GPU 105 is a display controller, which controls a liquid crystal display (LCD) 17 used as a display monitor of the computer 10. The GPU 105 uses the VRAM 105A as a work memory. A display signal generated by the GPU 105 is supplied to the LCD 17.

The south bridge 104 controls each device on a Low Pin Count (LPC) bus and each device on a Peripheral Component Interconnect (PCI) bus. Further, the south bridge 104 has a built-in Integrated Drive Electronics (IDE) controller for controlling hard disk drive (HDD) 111 and DVD drive 112. Further, the south bridge 104 has a function of performing a communication with the audio controller 106. The audio controller is an audio source device, and outputs playback target audio data to speakers 18A and 18B.

The wireless LAN controller 114 is a wireless communication device, which performs a wireless communication conforming to the IEEE 802.11 standard, for example. The IEEE 1394 controller 115 performs a communication with an external apparatus by means of a serial bus conforming to the IEEE 1394 standard.

The embedded controller/keyboard controller IC (EC/KBC) 116 is a one-chip microcomputer, which is integrated with an embedded controller for power management, and a keyboard controller for controlling keyboard (KB) 13 and touchpad 16. The embedded controller/keyboard controller IC (EC/KBC) 116 has a function of turning on/off the power of the computer in accordance with an operation of the power button 14 by user.

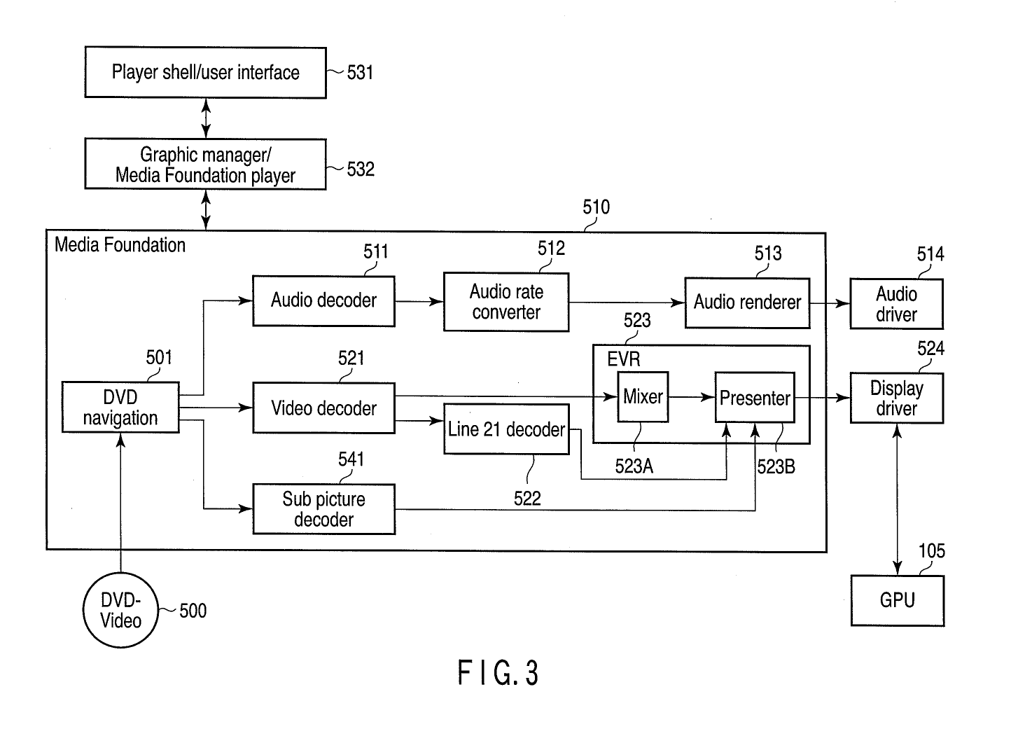

FIG. 3 shows the configuration of a DVD application program 202 executed by the CPU 101 of this apparatus to playback contents. A technology called Media Foundation is employed in this player software. Media Foundation is executed under Windows® environment, which is an operating system (OS) produced by Microsoft Corporation to play back content. Media Foundation is a Windows multimedia platform. Topology for supplying media data is generated using three kinds of pipeline components such as Media Source, Transform and Media Sink. The foregoing Media source is a component, which mainly handles input data and generates media data. The foregoing Transform is a component such as a decoder, which is an intermediate component for processing media data. The foregoing Media Sink is a component such as a renderer, which outputs media data.

DVD-VIDEO data played back by the DVD drive 112 is supplied to a DVD navigation 501. The DVD-VIDEO data is encrypted by a content scramble system (CSS). The navigation 501 decrypts the encrypted data to separate a video pack (V_PCK), a sub-picture pack (SP_PCK) and an audio pack (A_PCK) from the decrypted data. Then, the navigation 501 supplies the audio pack (A_PCK) to an audio decoder 511. Further, the navigation 501 supplies the foregoing video pack (V_PCK) and sub-picture pack (SP_PCK) to a sub-picture decoder 541.

In this case, the DVD-VIDEO is stored with 30-FPS interlaced moving image data. When a DVD is played back and a moving image is displayed on the LCD 17, a sheet of frame image is generated from neighboring field images, and thereby, 60-FPS progressive moving images are displayed on the LCD 17.

The audio decoder decompresses compressed and coded audio information to convert it into non-compression audio data, and then, supplies the audio data to an audio rate converter 512. The audio rate converter 512 converts the audio data into a suitable sampling rate, and thereafter, supplies it to an audio renderer 513. The audio renderer 513 synthesizes the supplied audio data and audio data generated by other software operating on the computer, and then, supplies the synthesized audio data to an audio driver 514. The audio driver 514 controls the audio controller 106 so that audio is output from speakers 18A and 18B.

In the video decoder 521, if line 21 data is included, the video decoder 521 supplies the line 21 data to a line 21 decoder 522. The video decoder 521 decodes a video pack (V_PCK) to generate a field image. The sub-picture decoder 541 decodes a sub-picture pack (SP_PCK). The decoded data is supplied to an expansion video renderer 523.

A mixer 523A of the expansion video renderer 523 executes interlaced/progressive conversion (I/P conversion) with respect to a plurality of frames supplied from the video decoder 521. In this way, the mixer 523A generates a frame image from the field image. The generated frame image is supplied to a presenter 523B.

The presenter 523B executes the following processings; namely, it synthesizes a sub-picture (compressed sub-picture pack) and a closed caption in a frame image and renders a frame.

Moving image data output from the presenter 523B is supplied to a display driver 524. The display driver 524 controls the GPU 105 to display a moving image on the LCD 17.

A player shell/user interface 531 executes a processing related to display of a playback control panel. Moreover, the player shell/user interface 531 notifies a command corresponding to a button operated by user to a Media Foundation 510 by way of a graphic manager/media foundation player 532. The Media Foundation 510 controls topology formed of navigation 501, audio decoder 511 and video decoder 521 in accordance with the notified command.

When the capability of the CPU 101 is low, time is taken to execute a processing for releasing the CSS; for this reason, a frame supplied to the presenter 523B is delayed. As a result, a dropped frame is unperiodically generated. This apparatus changes a frame rate of moving image data output to the GPU 105 in accordance with the capability of the CPU 101 in order to prevent a dropped frame from being unperiodically generated. Hereinafter, the configuration of changing a frame rate of moving image data output to the GPU 105 in accordance with the capability of the CPU 101 will be described.

The graphic manager/media foundation player 532 acquires the capability of the CPU 101, that is, the number of cores and the clock rate, from the operating system 201 when the computer starts. Based on the acquired capability, the player 532 determines whether or not there is a possibility that a dropped frame is unperiodically generated. Then, in accordance with the determined result, the player 532 sets a frame rate of a moving image data output to the GPU 105 from the presenter 532B by way of the display driver 524.

The graphic manager/media foundation player 532 sets an I/P conversion method executed by the mixer 523 to any of first and second conversion methods in accordance with the capability of the CPU 101. More specifically, if the capability of the CPU 101 satisfies a preset capability and there is no possibility that a dropped frame is unperiodically generated, the mixer 423A gives instructions to execute I/P conversion using the first conversion method to the media foundation 510. Conversely, if the capability of the CPU 101 does not satisfy a preset capability and there is a possibility that a dropped frame is unperiodically generated, the mixer 423A gives instructions to execute I/P conversion using the second conversion method to the media foundation 510.

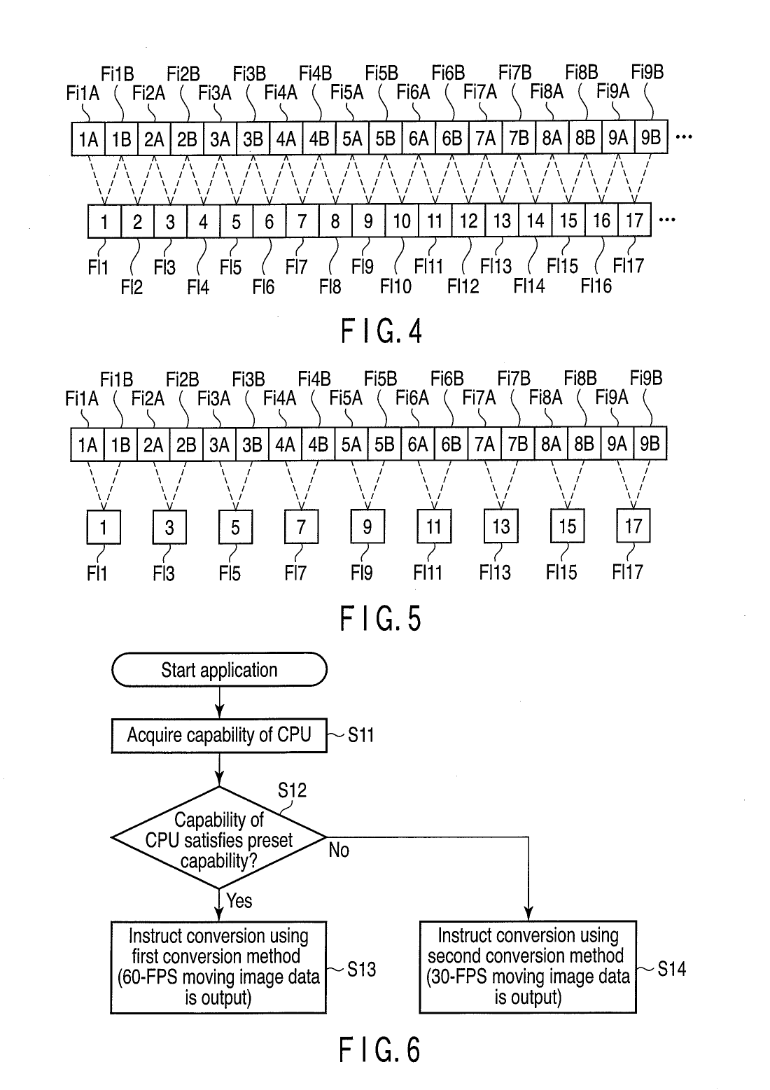

According to the foregoing first conversion method, the mixer 523A generates a frame image using neighboring field images. As seen from FIG. 4, the mixer 523A successively generates frame images F11, F12, . . . , F17 at 60 frames per second (FPS) from field images Fi1A, Fi2B, Fi2A, Fi2B, . . . , Fi9A, Fi9B successively input from the video decoder 521. Then, the mixer 523A outputs the generated frame images F11, F12, . . . , F17, . . . to presenter 523B. As a result, 60-FPS moving image data is output from the presenter 523B to the GPU 105 by way of the driver 524.

Moreover, according to the foregoing second conversion method, the mixer 523A generates a frame image using field images in the same frame. As seen from FIG. 5, the mixer 523A successively generates frame images F11, F13, F115, . . . , F117 at 30 FPS using field image of the same frame from field images Fi1A, Fi2B, Fi2A, Fi2B, . . . , Fi9A, Fi9B successively input. Then, the mixer 523A outputs the generated frame images F11, F12, . . . , F17, . . . to presenter 523B. As a result, 30-FPS moving image data is output from the presenter 523B to the GPU 105 by way of the driver 524.

Namely, the frame rate of moving image data according to the I/P conversion using the second conversion method becomes lower than that of moving image data according to the I/P conversion using the first conversion method. Therefore, the frame rate is reduced, and thereby, this is equivalent to the case where a dropped frame is unperiodically generated. When a dropped frame is unperiodically generated, it bothers the user. However, when a dropped frame is periodically generated, user unlikely to notice the generation of a dropped frame by a residual image; therefore, the user is not so bothered.

The procedure of setting a frame rate of moving image data output to the GPU 105 will be described below with reference to a flowchart of FIG. 6. In this case, the foregoing settings are executed when the DVD application program 202 starts.

Firstly, the graphic manager/media foundation player 532 acquires data on the capability (the number of cores, the operation frequency, etc.) of the CPU 101 from the operating system 201 (step S11).

First, the graphic manager/media foundation player 532 determines whether or not an acquired capability satisfies a preset condition (step S12). According to the foregoing preset condition, the CPU 101 has a plurality of cores therein, and the operating frequency of the CPU 101 is more than 2 GHz.

If it is determined that the capability of the CPU 101 satisfies the preset condition (Yes in step S12), the graphic manager/media foundation player 532 gives instruction to execute I/P conversion using the first conversion method to the media foundation 510 (step S13). Conversely, it is determined that the capability of the CPU 101 does not satisfy the preset condition (No in step S12), the graphic manager/media foundation player 532 gives instruction to execute I/P conversion using the second conversion method to the media foundation 510 (step S14).

When playback is performed, the mixer 523A generates a frame image in accordance with the instruction from the graphic manager/media foundation player 532, and then, outputs the generated frame image to the presenter 523B.

As described above, a frame rate is set in accordance with the capability of the CPU 101. In this way, a dropped frame is prevented from being non-continuously generated when moving image data played back; therefore, the user is unlikely to be bothered.

The foregoing embodiment relates to the case where DVD-VIDEO is played back. In this case, a frame rate may be changed in accordance with the capability of a CPU when other moving image data is played back.

Furthermore, the CPU 101 and the GPU 105 may be embedded in a semiconductor chip.

The various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the sprit of the inventions. The accompanying claims and their equivalents are intended to cover such forms or modifications as would fall within the scope and spirit of the inventions.

What is claimed is:

1. A playback apparatus comprising:
a graphic unit configured to generate a video signal suitable for outputting to a display device;
a central unit configured to decode encoded moving image data and to execute a program configured to generate second moving image data to be inputted to the graphic unit based on the decoded moving image data; and
a control unit configured to change a frame rate of the second moving image data based on the central unit's capability.

2. The apparatus of claim 1, wherein the decoded moving image data has an interlaced format, and the program is configured to convert the interlaced-format moving image data into progressive-format moving image data.

3. The apparatus of claim 2, wherein the control unit is configured to execute a control such that the conversion is carried out using a first conversion method when the capability of the central unit satisfies a preset condition, and carried out using a second conversion method when the capability of the central unit does not satisfy the preset condition.

4. The apparatus of claim 3, wherein the first conversion method is configured to generate a frame image from neighboring field images included in the interlaced-format moving image data, and
the second conversion method is configured to generate a frame image from field images of the same frame included in the interlaced-format moving image data.

5. The apparatus of claim 1, wherein the control unit is configured to execute a control to change the frame rate of the second moving image data to a value lower than a maximum frame rate generated by the program, when the central unit does not include a plurality of operation cores.

6. The apparatus of claim 1, wherein the encoded moving image data is encrypted, and
the program is configured to decrypt the encoded moving image data.

7. A method of controlling a playback apparatus configured to decode encoded moving image data by a program executed by a central unit, and to generate second moving image data to be inputted to a graphic unit, the method comprising:
with at least one computer processor,
acquiring a capability of the central unit; and
executing a control to change the second moving image data's frame rate based on the acquired capability.

8. The method of claim 7, wherein the decoded moving image data has an interlaced format, and the interlaced-format moving image data is converted into progressive-format moving image data.

9. The method of claim 8, further comprising
executing a control such that the conversion is carried out using a first conversion method when the capability of the central unit satisfies a preset condition; and
executing a control such that the conversion is carried out using a second conversion method when the capability of the central unit does not satisfy the preset condition.

10. The method of claim 9, wherein the first conversion method generates a frame image from neighboring field images included in the interlaced-format moving image data, and
the second conversion method generates a frame image from field images of the same frame included in the interlaced-format moving image data.

11. The method of claim 7, wherein executing a control to change the second moving image data's frame rate comprises changing the frame rate of the second moving image data to a value lower than a maximum frame rate generated by the program, when the central unit does not include a plurality of operation cores.

12. The method of claim 7, wherein the encoded moving image data is encrypted, and
the program is configured to decrypt the encoded moving image data.

13. A computer-readable medium having stored thereon instructions that, when executed by a computer comprising a graphic unit configured to generate a video signal suitable for outputting to a display device, and a central unit configured to decode encoded moving image data and execute a program configured to generate second moving image data to be inputted to the graphic unit based on the decoded moving image data, cause the computer to:
acquire a capability of the central processor; and
execute a control to change the second moving image data's frame rate based on the acquired capability.

14. The medium of claim 13, wherein the decoded moving image data has an interlaced format, and
the instructions further cause the computer to convert the interlaced-format moving image data into progressive-format moving image data.

15. The medium of claim 14, wherein the instructions further cause the computer to:
execute a control such that the conversion is carried out using a first conversion method when the capability of the central unit satisfies a preset condition; and
execute a control such that the conversion is carried out using a second conversion method when the capability of the central unit does not satisfy the preset condition.

16. The medium of claim 15, wherein the first conversion method is configured to generate a frame image from neighboring field images included in the interlaced-format moving image data, and
the second conversion method is configured to generate a frame image from field images of the same frame included in the interlaced format moving image data.

17. The medium of claim 13, wherein the instructions for causing the computer to execute a control to change the second moving image data's frame rate further cause the computer to change the frame rate of the second moving image data to a value lower than a maximum frame rate generated by the program, when the central unit does not include a plurality of operation cores.

18. The medium of claim 13, wherein the encoded moving image data is encrypted, and
the instructions further cause the computer to execute a processing of decrypting the encoded moving image data.
